(19) United States
(12) Patent Application Publication
(10) Pub. No.: US 2014/0188584 A1
(43) Pub. Date: Jul. 3, 2014

(54) PRODUCT PRICING SYSTEM ON ELECTRONIC COMMERCE USING THE INTERNET

(71) Applicants: Young-Nam Park, Seoul (KR); Ji-Hye Park, Seoul (KR); Won-Hyung Lee, Seoul (KR); Min-Hwan Park, Seoul (KR); Kyeong-Ho Jo, Seoul (KR)

(72) Inventors: Young-Nam Park, Seoul (KR); Ji-Hye Park, Seoul (KR); Won-Hyung Lee, Seoul (KR); Min-Hwan Park, Seoul (KR); Kyeong-Ho Jo, Seoul (KR)

(21) Appl. No.: 14/117,411

(22) PCT Filed: May 11, 2012
(86) PCT No.: PCT/KR2012/003741

§ 371 Date: Jan. 13, 2014

(30) Foreign Application Priority Data
May 13, 2011 (KR) 10-2011-0045187

(51) Int. Cl. G06Q 30/02; G06Q 30/08

(52) U.S. Cl. CPC G06Q 30/0239; G06Q 30/08; G06Q 30/0214
USPC 705/14.16; 705/26.3; 705/14.39

(57) ABSTRACT

In one embodiment, the product pricing system in e-commerce using the internet, comprises a sale condition management module receiving a sale condition information entered from a seller that includes a lowest set price, a customer price and a prepared number of a product, wherein the lowest set price for a product is determined according to whole sale of the prepared number of a product; a purchase condition management module generating purchase group information by counting a purchased number for each bid price through a product bid price and a purchased number of a product entered from a customer; a status management module generating discount information according to a purchased number of a product based on the sale condition information, and generating varying price information by adding the discount information and the purchase group information; and a pricing module generating a pricing information by setting a price of the product, wherein the price of the product set at the value where the purchase group information matches with the discount information.

In one embodiment, according to the product pricing system, the system provides the seller with price range setting rights and the consumer with price range selecting rights which enables both parties to actively and flexibly participate in setting the price thereby maximizing the profits of both parties.

### TECHNICAL FIELD

The present disclosure relates generally to a product pricing system in E-Commerce using the Internet. More specifically, the present disclosure relates to a product pricing system for providing the seller with price range setting rights and the consumer with price range selecting rights which enables both parties to actively and flexibly participate in setting the price thereby maximizing the profits of both parties.

### BACKGROUND

As modern society evolve, computer technology and network technology such as the internet developed, and with the fast growth of the technology, E-commerce became also prevalent in the field of commerce.

E-commerce is a type of industry where the buying and selling of products or services is conducted over electronic systems such as the Internet and other computer networks. E-commerce is popular due to the fact that it is convenient and cheap compared to the general offline method of transactions.

Recently, as social network services and mobile services etc. developed, joint purchasing became popular as a method of E-commerce. Generally, joint purchasing means two or more consumers gathering to purchase a product. Since the internet provides an environment in which many consumers can group or gather, joint purchasing is becoming popular to many consumers. Further, since joint purchasing may lower the price of the product compared to the case when purchasing the product individually, it is fueling an affirmative effect to the E-commerce market.

However, in the conventional joint purchasing method, the seller generally suggested the consumers with a price for a certain amount of products and the consumers could purchase the products for the price suggested by the seller or if the number of consumers who were willing to purchase the product could not reach a certain amount suggested by the seller, the joint purchasing deal would simply break down, depriving the consumers' opportunity to purchase the products. Thus, in this regard, the conventional joint purchasing method was a somewhat consumer-centered purchasing method, but largely the conventional method had the problem of the seller having the sole power to set the price of the product.

Moreover, since the seller had the power to set the price of the product, as the number of consumers who wished to purchase the product grew, the seller gradually raised the price of the product, eventually making the price as high as a normal offline purchase.

Therefore, in order to solve such problems of the prior art, a novel and an advanced product pricing system which provides the consumers to actively and flexibly participate in product pricing is needed in order to maximize the profits of both consumers and sellers.

### SUMMARY

### Technical Problems to be Solved

The present disclosure seeks to solve the problems of prior art and intends to maximize the profit of both sellers and consumers by providing a reasonable price for both parties.

The other purpose of the present disclosure is to control the consumer's purchase motivation by changing the discount rate information.

The other purpose of the present disclosure is to let the seller and consumer recognize the price varying status by means of display.

Yet another purpose of the present disclosure is to change the discount information of an unpopular product over time to motivate the consumer to purchase the products.

Further, another purpose of the present disclosure is to prevent the consumer who has entered in a slightly low bid price than the consumer price to miss the opportunity of purchasing the product.

Another purpose of the present disclosure is to use the advertising effect that can be obtained from the consumer's social network service and return the benefit to the consumer by providing the consumer with a discount, thereby enabling a satisfactory shopping for the consumer.

Another purpose of the present disclosure is to group popular products and sell them at a low price so that both sellers and consumers could satisfy.

Another purpose of the present disclosure is to induce the consumer to involve other consumers in the E-commerce, and further provide discounts to the consumer according to the number of invited consumers, thereby inducing the consumer to actively participate in involving other consumers in the E-commerce.

### Means for Solving the Problem

The present disclosure provides a product pricing system in e-commerce using the internet, comprising: a sale condition management module receiving a sale condition information entered from a seller that includes the lowest set price for a product determined according to a prepared number of a product and a whole sale of the prepared number of a product; a purchase condition management module generating purchase group information by counting a purchased number for each bid price through a product bid price and a purchased number of a product entered from a customer; a status management module generating discount information varying between the lowest set price and the customer price according to a purchased number of a product based on the sale condition information, and generating varying price information by adding the discount information and the purchase group information; and a pricing module generating a pricing information by setting a price of the product, wherein the price of the product set at the value where the purchase group information matches with the discount information.
In one embodiment, there is provided a system, wherein the discount information is formed as a function graph of [Price=−{(Customer price−Lowest set price)/Prepared number of product}*Purchased number of product+Customer price}], the purchase group information is formed as a bar graph corresponding the purchased number of product and the bid price into the x-axis and the y-axis, respectively; the varying price information is represented as a graph by adding the discount information and the purchase group information.

In another embodiment, there is provided a system, wherein the sale condition information includes information on a sale set period, the customer price in the function formula of the discount information is transferred to the customer price that additionally subtracts the value of {Basic discount price*[(sale date number−1)/sale set period]} thereby enabling the discount information to vary with the flow of time by including a discount information and the number of dates for sale showing the number of dates elapsed from a start date for sale.

In still another embodiment, there is provided a system, wherein the pricing module further includes a pricing information transfer unit that extracts a customer who entered a bid price lower than the pricing information from the purchase group information and transfers the pricing information generated within the sale set period to the customer.

In still another embodiment, there is provided a system, further comprising a URL information input unit that receives from a customer a URL information of a social network community operated by the customer where the advertising information on the product is posted; a text determination unit generating a text level information that decides a degree of promotion of the advertising information by extracting the advertising information and analyzing it with text mining; a social promotion management module includes an additional discount provision unit providing a differentiated discount to the customer according to the text level information.

In still another embodiment, there is provided a system, wherein the advertising information includes a link icon linked to a webpage operated by the system; the social promotion management module includes a link information extraction unit generating link information by extracting and counting log information showing access by an unspecified internet user through the link icon to a webpage operated by the system; the additional discount provision unit provides a differentiated discount to the customer according to the value of the sum of the text level information and the link information.

In still another embodiment, there is provided a system, further comprising an interest index extraction unit calculating each interest index of multiple products; a product bundle generation unit generating product bundle contents extracting at least more than one product with a high interest index, thereby enabling the products to be sold simultaneously; a product bundle management module includes a product bundle information transfer unit transferring product bundle information to a customer who enters the purchase condition information for one of the products included in the product bundle contents.

In still another embodiment, there is provided a system, further comprising a customer invitation module that invites other customers to the pricing system by receiving the other consumers' information from the customer; an invitation discount module discounting the price for an inviting customer, according to the number of customers who entered the bid price higher than the pricing information among the invited customers.

In still another embodiment, there is provided a system, wherein the invitation discount module discounts the price for an inviting customer by a certain amount, wherein the certain amount is calculated by multiplying the invitation discount rate (%) with the number of customers who entered the bid price higher than the pricing information among the invited customers, and the invitation discount module discounts the price for the invited customers by the invitation discount rate (%).

### The Effect

A product pricing system in E-commerce using the internet according to the present disclosures may
1) provide the seller with price with price range setting rights and the consumer with price range selecting rights which enables both parties to actively and flexibly participate in setting the price thereby maximizing the profits of both parties,
2) allow the seller and consumer to recognize the price variation status through displaying the graph including real-time status of sales,
3) stimulate the purchase motivation of the consumer by lowering the price of the unpopular product as time passes,
4) allow the consumer to correct the bid price of the product who have entered in a slightly lower bid price,
5) be economical to the seller as well as the consumer in that the seller may use the social network service operated by the consumer to seek some marketing effect and the consumer may be provided with some benefit by letting the seller use the social network service operated by the consumer,
6) provide a deal that both seller and consumer may satisfy by grouping popular products and providing them at a low price,
7) control the sales of the product by varying the discount rate,
8) have the effect of inducing participation of more consumers to the system since inviting consumers will lower the bid price leaving more room for discounts.

### BRIEF DESCRIPTION OF THE DRAWINGS

FIG. 1 is an illustration of a product pricing system in E-commerce using the internet, including the overall principles and operations thereof.

FIG. 2 illustrates a block diagram of the components consisting the product pricing system in E-commerce.

FIG. 3 is a diagram showing variable price information of a fixed discount rate according to one embodiment of the invention.

FIG. 4 is a diagram showing variable price information of a varying discount rate according to one embodiment of the invention.

### DETAILED DESCRIPTION

The preferable embodiments of the present disclosure would be explained in detail with reference to the accompanying drawings. Same reference numerals in the figures indicate same components.

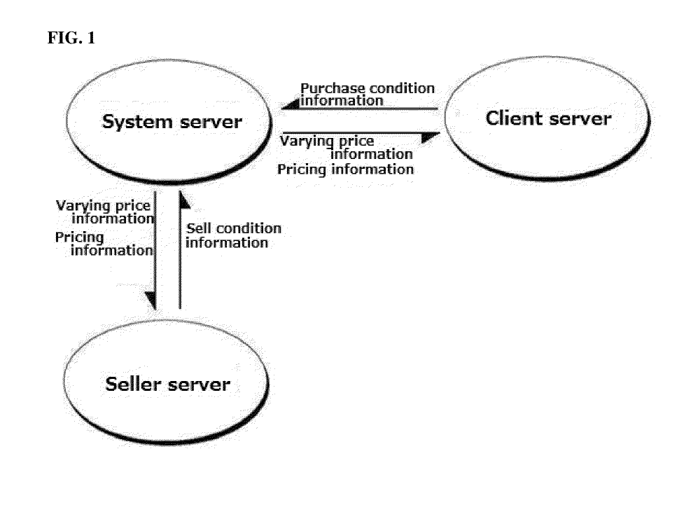

FIG. 1 is an illustration of a product pricing system in E-commerce using the internet, including the overall principles and operations thereof.

As illustrated in FIG. 1, in the product pricing system 100 in E-commerce using the internet according to the present disclosure, the system server, the seller server managed by the seller, the client server managed by the consumer (generally consumer's personal computer or mobile devices etc.) are linked together, and the seller server is provided by the seller with the lowest price of the product (lowest set price) and the highest set price of the product (consumer price) according to predetermined criteria and the consumer enters in the bid price (which ranges somewhere between the lowest price of the product and the highest set price of the product) and the number of products the consumer seeks to purchase through the client server, and utilizes the information to set the price of the product.

The product pricing system 100 according to the present disclosure may be utilized by using communications network such as the internet, WIFI (wireless fidelity), 3G (3^{rd} generation) etc., and the system server needs to work cooperatively with the seller server or the client server in order to grant the seller with the right for setting the price range of the product and to grant the consumer with the right to select the price of the product, thereby maximizing the benefits of both the seller and the consumer.

The system server incorporates DB server, web server, mobile server etc., and the system server manages a separate web page (internet web site or mobile web site etc.) in which the seller and the consumer may log-in to the web page to enter product information. In particular, the seller may enter in the sales conditions regarding the price range of the product and the consumer may also enter in the purchase conditions regarding the product and by formulating a variable price information (which indicates the varying price of the product in real-time) through the inputted conditions, the seller and the consumer may be provided with an interface that allows the seller and the consumer to communicate in real-time through a web environment.

According to the mechanism explained above, the system server manager etc. and the seller and the consumer may communicate with each other based on the internet, and the system according to the present disclosure may allow the seller to sell products to many unspecified consumers at a competitive price which enables the seller to gain benefits as well as clear out the stock. Further, the system according to the present disclosure may allow the consumer to directly participate in setting the price of the product which enables them to purchase a product at a reasonable price. Through the system according to the present disclosures, the seller and the consumer can both maximize their profits.

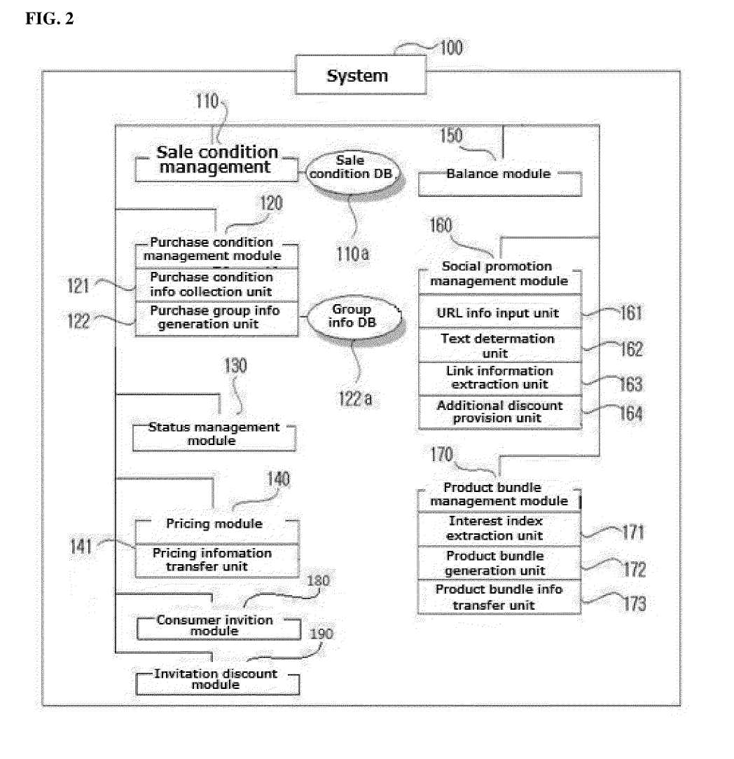

FIG. 2 illustrates a block diagram of the components consisting the product pricing system in E-commerce.

As depicted in FIG. 2, the product pricing system 100 according to the present disclosure basically comprises a sale condition management module 110, a purchase condition management module 120, a status management module 130, a pricing module 140, and a balance module 150.

Before getting into the details of each component, in order to implement the product pricing system 100 according to the present disclosure, it is preferable for the seller and the consumer to become a member of the web page managed with the system 100 and assist them to use the system 100 regularly. However, since such technology related to the above is a well-known technology in the E-commerce field, explanations related to such technology will be omitted here.

The sale condition management module 110 receives information related to the product by the seller and creates sale condition information and stores and manages the information.

The sale condition information may comprise the product information such as the name of the product the seller is trying to sell, the usage of the product, the features of the product (which may be presented as a text or an image etc.), sale set period including the start date and the end date of sales, lowest set price of the product, the number of products that needs to be sold in order to maintain the minimum margin when sold at the lowest price (prepared number of products), the highest set price of the product (consumer price) etc.

In particular, the start date and the end date is generally a time limit in proceeding with joint purchasing or auction etc. The prepared number of products indicates the number of products prepared to sell between the start date and the end date. The lowest set price indicates the price set on the premise that the prepared number of products will be sold out during the sell period, and such price is set according to the basic margin and the base cost of the product (e.g., lowest set price=basic margin+base cost of the product). The consumer price indicates the price set when the product was released in the market or the price at which the other off-line shops or other internet shopping malls etc. sell their product.

The sale condition management module 110 not only receives the sales condition from the seller and creates the sale condition information and classify and store in the sale condition DB 110a but also displays the sale condition information on the web page such that the information may be disclosed to many unspecified consumers. The sale condition information stored in the sale condition DB 110a functions as a certain criteria for product pricing in the product pricing system 100 of the present disclosure.

The purchase condition management module 120 receives purchase condition information from the consumer who recognized the sale condition information displayed through the web page. The purchase condition management module 120 classifies the purchase condition information in real-time, stores the information and displays the information. The purchase condition management module 120 comprises a purchase condition information collection unit 121 and a purchase group information generation unit 122.

The purchase condition information collection unit 121 receives the purchase condition information from the consumer and classifies and stores the information. The purchase condition information may include bid price (price the consumer is willing to pay the purchase the product), the number of products the consumer wishes to buy, and the personal information of the consumer.

The bid price is the price that the consumer arbitrarily selected which ranges between the lowest set price and the highest set price (consumer price). For example, if the lowest set price is 10,000 won and the consumer price is 30,000 won, the consumer may set a price he/she wishes that ranges between 10,000 won and 30,000 won. The number of products indicates the number of products the consumer wishes to buy according to the selected bid price. The consumer personal information is the basic personal information of the consumer who inputted the bid price and the number of products, e.g., ID, name, phone number, mobile number, e-mail address etc. may be included in the information.

It is preferable for the consumer to pay the purchase cost according to the bid price and the number of products to purchase when the purchase condition information is inputted (prepayment method). If a consumer who is not determined to purchase the product enters in the purchase condition information, the overall number of products and the bid price will be calculated based on the false purchase condition information by the consumer, and if the consumer finally does not decide to purchase the product, the seller is left with a loss by the shortage of products that the seller could not sell due to the order cancellation of the consumer. The product pricing system 100 according to the present disclosure obviates the possibility of the seller taking on the damages that the seller might have due to the order cancellation of the consumer. However, in another embodiment, the payment may be arranged after the final price is set according to one's needs.

The purchase group information generation unit 122 receives each of the purchase condition information collected from purchase condition information collection unit 121 based on the input from the consumer, and groups the purchase condition information based on the bid price the consumer selected and creates a purchase group information and classifies, stores the information in the group information DB 122a. The group information is formulated by counting the total number of products the consumer wishes to purchase at a certain price. That is, in the 11,000 won group where the bid price is 11,000 won, the total number of products who wishes to purchase the product at 11,000 won is counted and the other purchase group information is formed in a similar manner according to the bid price.

To be specific, the total number of products counted includes the number of products which have the higher price than the inputted bid price. That is, the number of products counted for a certain bid price includes the accumulated number of products for a bid price lower than the above bid price. Here, the accumulated number of products is counted regardless of the order of the consumers entering in their information. For example, let's say that the number of product a consumer is purchasing is one, and the number of consumers who inserted 11,000 won for the bid price is three, and the number of consumers who inserted 10,000 won for the bid price is two. Since, the consumer who entered in 11,000 won as the bid price is willingly to buy the product at 10,000 won, the total number of products to be purchased for the 11,000 won group is three, but the total number of products to be purchased for the 10,000 won group is five (3+2). If 4 additional consumers enter in their bid price at 9,000 won and 5 consumers enter in their bid price at 12,000 won, the total number of products to be purchased for the 12,000 won group is five, where total number of products to be purchased for the 11,000 won group is eight (5+3), the total number of products to be purchased for the 10,000 won group is ten (5+3+2), and the total number of products to be purchased for the 9,000 won group is fourteen (5+3+2+4).

This method is different from the conventional joint purchasing method where the seller predetermines the price of the product and gathers the consumers according to the set price which was a passive way to determine the price of the product viewed from a consumer's perspective. According to the present disclosure, consumer may enter in their bid price for the product and grouping is performed according to the bid price where the purchase group information created here is used in turn in the status management module 130 and the pricing module 140 to set the price of the product. The present disclosure seeks to proactively and spontaneously induce the participation of the consumer in the process of setting the price of the product.

The status management module 130 creates a discount information based on the price varying between the consumer price and the lowest set price according to the sale condition information (e.g., product price and number of products), and further creates a variable price information by adding the discount information and the purchase group information and displays the information in real-time.

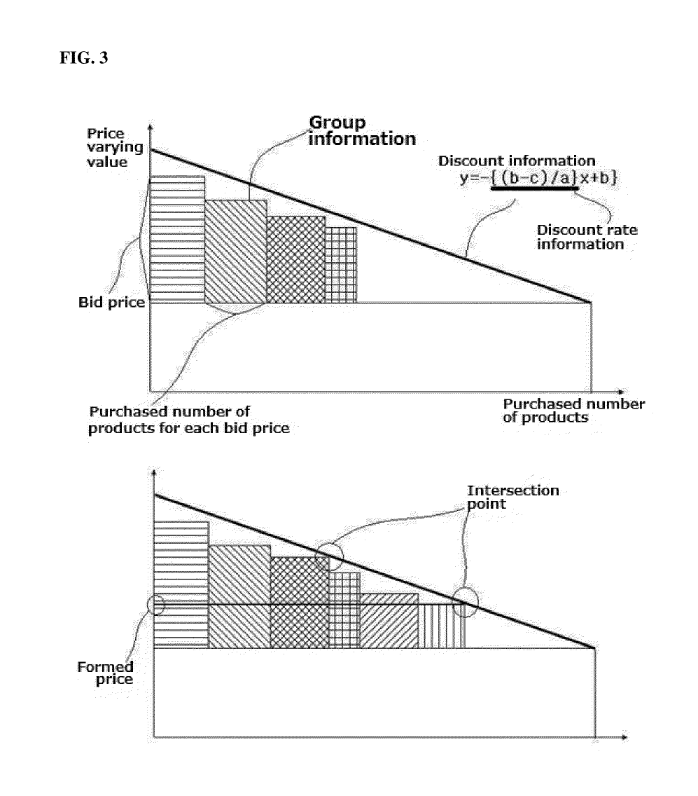

FIG. 3 is a diagram showing variable price information of a fixed discount rate according to one embodiment of the invention.

According to FIG. 3, the variable price information is combined with the discount information and the purchase group information. For example, the discount information may be represented as formula, y=−{(b−c)/a}x+b} (y: price, x: purchased number of products, a: prepared number of products, b: consumer price, c: lowest set price) which is a price varying function that can also be represented as a graph. The purchase group information is represented as a bar graph which indicates the bid price and the number of products for each group. The bar graph is based on the x and y axis of the graph and the x value in the bar graph indicates the number of products for a group and the y value indicates the bid price for that group. It is desirable to display the above information in real-time so that it is clear how the product price is being set.

The discount information includes the discount rate information, where the discount rate information includes the degree of the discount information varying according to the number of products. When the discount information is represented as a price varying function graph, the discount information becomes the inclination of the graph. In the above example, the discount rate becomes {(b−c)/a}. As such, the discount rate may be consistent according to the number of products (in this case since the inclination (i.e., discount rate) has a consistent value, it is depicted as a straight line).

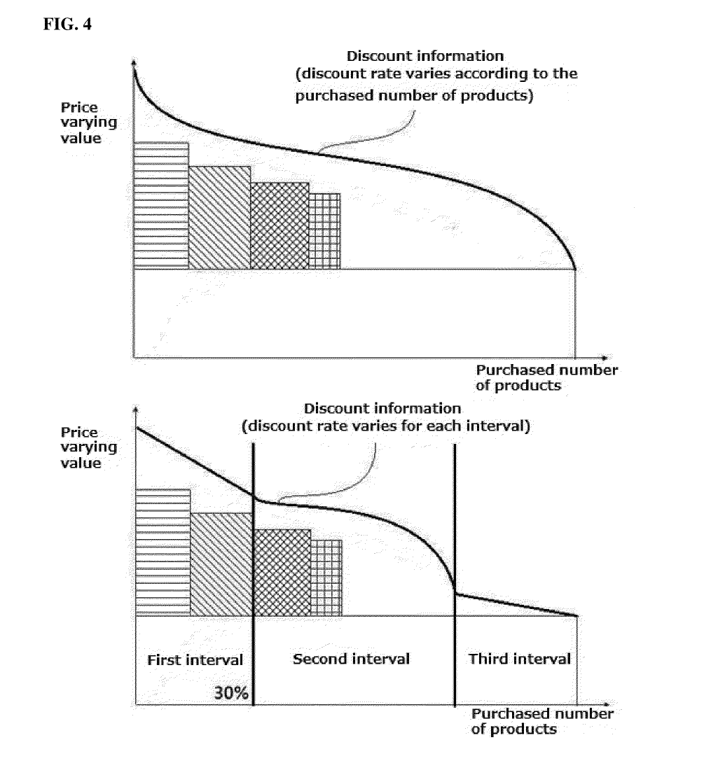

In one embodiment, the discount rate itself may vary according to the number of products to be purchased. That is, in the price varying graph for the discount information, the discount rate which is the inclination of the graph may vary according to the number of products, therefore the price varying function graph may have the form of a log function, exponential function, Gaussian function graph or other graphs other than a straight line graph. In another embodiment, if the discount rate is set to vary larger as the number of products increase, the discount information and the purchase group information may be matched easily as the number of products increase, entailing the effect of the consumer to purchase more products (see the upper portion of FIG. 4).

According to yet another embodiment, it is also possible to set different discount rate for different multiple intervals by dividing the intervals according to the prepared number of products. For example, in the lower portion of FIG. 4, it shows that the prepared number of products is divided into 3 intervals (i.e., the first interval, the second interval, and the third interval). If the purchased number of products is within 30% of the prepared number of products (the first interval), the discount rate can be applied relatively higher than the other intervals, thereby inducing the participation of the consumers during the initial period.

To explain in detail, the price varying function has (b−c)/a as the inclination (i.e., discount rate: dividing the prepared number of products to the difference between the consumer price and the lowest set price). The graph has a y-intercept of b (consumer price), and the x value when the y equals c (lowest set price) indicates the prepared number of products. Further, as the number of products to be purchased increases the y-value decreases and the varying range of the y-axis is from c (lowest set price) to b (consumer price).

Additionally, the sale date number indicating the date passed from the sale start date may be included in the variable price information. This is to let the discount information fluctuate over time, in case the pricing information is not formed during the sale set period according to the sale condition information (that is, when there is no intersection formed between the bar graph and the function graph). For example, price varying function including the sale date number is y=−{(b′−c)/a}*x+b′ where b′=b−{base discount price*[(sale date number−1)/sale set period]}, and [ ] indicates a Gaussian function. The base discount price is a randomly set value for discounting as the sale date number increases. The base discount price can be inputted by the seller through sale condition management module 110 and could also be arbitrarily set according the product pricing system 100 according to the present disclosure.

In other words, if the sale set period is set to 7 days and the base discount price is set at 1000 won, the price varying function including the sale date number is formed such that as time passes the consumer price drops 1000 won every 7 days. However, even if the sale date number increases for the price varying function including the sale date number, the lowest set price is remained unchanged and rather the overall inclination of the function graph is changed so that the minimum profit of the seller will be guaranteed.

When the varying price information including the sale date number is created, it is possible to make the price of an unpopular product to gradually decrease over time, and this may induce the consumers to purchase the low priced product while the lowest set price of the seller is remained unchanged which allows both parties to have a reasonable transaction.

The bar graph represents the purchase group information and as depicted in FIG. 3, a group with a high bid price is represented near the origin and a group with lower bid price is represented far toward the right side of the x-axis. This is under the premise that group with high bid price will readily purchase the product when the bid price is set to a lower bid price than the one they have inserted.

The y-axis value when the function graph and the bar graph intersects becomes the price of the product and the consumers are able to recognize the product pricing process in real time through the varying price information displayed by the status management module 130. The varying price information provides the consumer with important information in determining the bid price and the number of products to purchase.

Such varying price information is desirable to present it as a graph like FIG. 3 so that the consumer can recognize the product pricing process, but the varying discount contents may be represented as a table, text, or certain images etc. as well.

The consumer can input or modify the purchase condition information during the sale set period included in the sale condition information, and the varying price information should be displayed on the web page during the sale set period. In this regard, in order for the varying price information and the inputted purchase condition information to be reflected real-time, the purchase condition management module 120 and the status management module 130 must have interworking relationship with each other.

The pricing module 140 creates pricing information based on the price of the product matched according to the discount information and the purchase group information. That is, in the varying price information, the price value when the function graph and the bar graph intersect becomes the product price.

As time passes and the number of consumers who input the purchase condition information increases, multiple intersections may occur. In this case, the lowest price among the multiple intersection points formed within the end date should be selected as the price of the product.

Additionally, the pricing module 140 may additionally include pricing information transfer unit 141.

During the sale set period, if the bar graph and the function graph intersects before the sale end date, and when the price is set (the price is formed at the point of intersection), the pricing information transfer unit 141 transfers the pricing information to the consumers who have entered in a bid price lower than the formed price, allowing the consumers to modify their bid price. In other words, it is one purpose of the present disclosure to allow the consumers who entered in a slightly lower bid price than the formed price to modify their bid price so that the consumers would not be deprived of their opportunity to purchase the product.

One method of notifying the consumers with the pricing information is to extract the e-mail address from the consumer's personal information and send texts or contents including the pricing information. Other method is to extract the mobile phone number from the consumer's personal information and send it through MMS or SMS, but such transfer methods are not limited to those set forth here.

By including the pricing information transfer unit 141, the consumers may be allowed to purchase products that were formed at a price slightly higher than the bid price. Since the product pricing system according to the present disclosure, prevents the consumer to miss the opportunity of purchasing a product, it allows the consumer to have a reasonable and effective consumption.

The balance module 150 calculates the payment of the product according to the pricing information (or the formed price). If the product pricing system 100 is designed to make the consumer pay right when the consumer enters in the purchase condition information, the consumers who have entered in a bid price higher than the pricing information is refunded with the price difference and provided with the purchased product. For those consumers who have entered in a bid price lower than the pricing information, the consumers are completely refunded and the product purchase process is cancelled.

However, in case it is not a pre-payment method, for the consumers who have entered in a bid price same or higher than the pricing information, the balance module may receive the payment information for that product and make the calculations related to the product and provide the consumer with the purchased product.

Based on the above technical features, the product pricing system 100 may allow the sellers and the consumers to own the right to participate in forming the price of the product by actively and flexibly controlling the product price, thereby maximizing the profits of both parties.

Additionally, the product pricing system 100 according to the present disclosure may include the social promotion management module 160 and the product bundle management module 170.

The social promotion management module 160 provides a discount for the consumers who have publicized and advertised the product information in the social network community operated by the consumer. That is, by posting the product that the consumer seeks to purchase by entering the purchase condition information, the social promotion management module 160 provides the consumer with a discount according to the advertising effect. The social promotion management module 160 comprises a URL information input unit 161, a text determination unit 162, a link information extraction unit 163, and an additional discount provision unit 164.

The URL information input unit 161 receives the URL information of the social network community operated by the consumer who has posted the advertisement information related to the product.

The advertisement information may include the basic information of the product, the reviews of the consumer related to the product, the price information of the product, the principle of the pricing process according to the product pricing system 100 etc. and it may also include link icons which are linked to the link information extraction unit 163. The link icon is an icon to link from the social network community operated by the consumer to the web page operated by the system server. It is preferable to link the information related to the product that the consumer is advertising over the social network community to the web page operated by the system 100. The link icon may be a text including the URL address or may be a certain image and could also be an icon provided by the system 100 according to the present disclosure.

The text determination unit 162 access the social network community web page where the consumer posted the advertisement information through the URL information and extracts the advertisement information from the web page, and analyzes the text included in the advertisement information using text mining and creates a text level information of the text.

The text determination unit 162 comprises an object word extraction mean, modifier word extraction mean, a publicity information creation mean. The object word extraction mean is used to further detect and extract among the various objects of the extracted texts an object word related to the product (e.g., name of the product, pronoun indicating the product etc.). The modifier word extraction mean is used to extract the modifier word associated with the object word and the particle, and the publicity information creation mean is used to recognize the expression or the emotional state of the wording (e.g., very good, good, normal, bad, worse, or comfortable, convenient, inconvenient, complicated etc.) formed by the object word and the particle based on the publicity vocabulary library.

Based on the above method of creating a text level information of the advertisement information posted on the social network community by the consumer, it is possible to indirectly assess the degree of contribution the consumer's posting of the product makes on the overall publicity of the product.

The link information extraction unit 163 extracts the log information of an unspecified internet user who accessed the web page operated by the system 100 through the link icon. In particular, the link information extraction unit 163 counts the access number of the unspecified consumers who have visited the web page (shopping mall page) operated by the system 100 through clicking the link icon included in the consumer's social network community which includes the advertisement information related to the product.

This is used to measure how much the advertisement information posted on the consumer's social network community gained interest of the internet user, and based on the degree of the link information number, it is possible to recognize how much the consumer's posting effected the advertisement of the web page operated according to the system 100.

An additional discount provision unit 164 provides a differentiated discount to the consumer according to the text level information and the link information. It is preferable to apply a higher discount when the indirect publicity effect of the advertisement information (text level information) is greater and the direct publicity effect of the link information is greater. A linear formula such as, Y=ax1+bx2 may be used where Y is the discount degree, x1 is the text level information, x2 is the link information and a, b are weights that are applied to the text level information and the link information, respectively. It is preferable to apply the weight to be higher for the link information than the text level information, and in order for the text level information to be applied to the linear equation, it must be represented as a number according to the indirect publicity degree.

The discount provided to the consumer by the additional discount provision unit 164 may be one of giving out a coupon, discounting the total price of the product to a certain percentage, or exempting the consumer of incidental fees such as shipping fees, but the methods are not limited to the above examples.

By adding the social promotion management module 160 to the system 100, the system operator may achieve the advertising effect provided by the consumer's social network service thereby minimizing the advertisement fee. Further, the consumer is provided with discounts on the product merely based on positing the advertisement information on their social network community, and therefore it is beneficial and effective to both parties.

The product bundle management module 170 groups multiple products interested by the consumers and sells them in a bundle which allows the seller to invite more consumers and allows the consumers to purchase multiple products at a lower price, which is effective for e-commerce.

The product bundle management module 170 may include the interest index extraction unit 171, the product bundle generation unit 172, and the product bundle information transfer unit 173.

The interest index extraction unit 171 creates an interest index for each product by calculating the interest index of each of the multiple products registered in the system server. The method for calculating the interest index is to use the purchased number of each products, total visitor number of the web page that the product has been posted, or the number of clicks as parameters and quantify the parameters to apply them to the linear formula such as “Y=ax1+bx2+ . . . ”, where a, b, . . . are weights added to each parameters. However, the method for calculating the interest index can be calculated by another method.

The product bundle generation unit 172 creates a product bundle contents consisting of multiple products within a certain category that has an interest index higher than a certain level.

The product bundle formed through the product bundle generation unit 172 undergoes the same pricing process as other products. However, the discount made for the product bundle should be the same or at least lower than the total sum of the consumer price of the products but should be higher than the total sum of the lowest set price of the products.

The product bundle information transfer unit 173 transfers the product bundle information including the basic information related to the product bundle contents and the varying price information of the product bundle to the consumer who have entered in the purchase condition information for one or more products that are included in the product bundle contents. One of the method for notifying the consumer with the product bundle information is to extract the e-mail address or the mobile phone number of the consumer from the person information and send it through e-mail or MMS, SMS etc. However, it is also possible to use other methods to notify the consumer with the product bundle information.

The product bundle information transfer unit 173 enables the consumers who have purchased one of the products in the product bundle to purchase other products in the product bundle at a lower price, and this also allows the seller to gather more consumers which may maximize the profits of the seller.

In one embodiment of the present disclosure, the product pricing system may include a consumer invitation module 180 that invites other consumers based on the other consumer's information inputted from the inviting consumer, and the invitation discount module 190 that provides discounts that proportionally increase based on the number of invited consumers that inputted a bid price higher than the pricing information to the inviting consumer who invited the other consumers.

The consumer invitation module 180 is a module that allows the consumer already participating in the product pricing system (hereinafter, “inviting consumer”) to invite other consumers, and further allows more consumers to participate in the purchase and product pricing process thereby inducing more consumers to actively participate in the product pricing process. The other consumers' information indicates the arbitrary information associated with the other consumers. For example, the other consumers' information may include phone number, ID of a social network service etc., but it is not limited to the above, but the e-mail may be most preferable since the e-mail can indicate the URL which provides direct access to the product pricing system. The other consumers invited through the consumer invitation module (hereinafter, “invited consumer”) participates in the product pricing system by entering in their bid price and number of products through the purchase information management module 120.

Invitation discount module 190 provides discount only to inviting consumers and the amount discount is proportional to the number of consumers who entered in the bid price higher than the pricing information among the invited consumers. That is, for those consumers who have not invited other consumers, the original price is applied, and discount is given only to inviting consumer. However, the discount is provided not proportionally to all the invited consumers but the invited consumers that entered in the bid price higher than the pricing information. Thus, since the only invited consumers who have actually purchased the product is being counted, it is possible to prevent senseless random invitations that were made to merely receive discounts. The inviting consumers would need to actively advertise and induce participation of other consumers in order to receive higher discounts.

In particular, the invitation discount module 190 determines the invitation discount price by multiplying the number of consumers who have entered in a bid price higher than the pricing information to the invitation discount rate (%), and provides discount to the inviting consumers by subtracting the invitation discount price from the formed price. For example, if the invitation discount is 5%, and the number of consumers who entered in the bid price higher than the pricing information among the invited consumers is 10 people, the invitation discount price becomes 50% of the formed price and the inviting consumer can purchase the product at half the price of the formed price. In case the number of consumers who have entered in a bid price higher than the pricing information is more than 100/(invitation discount rate %), the inviting consumer can purchase the product for free (in the above embodiment, if the invitation discount rate is 5%, the number of consumers would be 20 (100/5)).

Further, the invitation discount module 190 provides the invitation discount rate (%) to invited consumers as well, thereby actively inducing more consumers to participate in the product pricing system.

As such, since the consumer invitation module 180 and the invitation discount module 190 both provides discount to inviting consumers and invited consumers, the invited consumers can also invite other consumers thereby actively inducing the participation of more consumers.

As described above, the specification and the drawings were explained in relation with the product pricing system 100 in E-commerce using the internet, but it is to be understood that the subject matter defined in the appended claims is not necessarily limited to the specific features or acts described above. Rather, the specific features and acts described above are disclosed as example forms of implementing the claims and various modifications can be made without departing from the spirit or scope of the disclosure.

| | |
|---|---|
| 100: system | 110: sale condition management module |
| 110a: DB sale condition DB | 120: purchase condition management |
| | module |
| 121: purchase condition information collection unit | 122: purchase group |
| | information generation unit |
| 122a: group information DB | 130: status management module |
| 140: pricing module | 141: pricing information transfer unit |
| 150: balance module | 160: social promotion management module |
| 161: URL information input unit | 162: text determination unit |
| 163: link information extraction unit | 164: additional discount provision unit |
| 170: product bundle management module | 171: interest index extraction unit |
| 172: product bundle generation unit | 173: product bundle information transfer |
| | unit |
| 180: consumer invitation module | 190: invitation discount module |

What is claimed is:

1. A product pricing system in e-commerce using the internet, comprising:
a sale condition management module classifying and saving sale condition information entered from a seller that includes a lowest set price, a customer price and a prepared number of a product, wherein the lowest set price for a product is determined according to whole sale of the prepared number of a product;
the lowest set price for a product determined according to a prepared number of a product and a whole sale of the prepared number of a product;
a purchase condition management module generating purchase group information by counting a purchased number for each bid price through a product bid price and a purchased number of a product entered from a customer;
a status management module generating discount information varying between the lowest set price and the customer price according to a purchased number of a product based on the sale condition information, and generating varying price information by adding the discount information and the purchase group information; and
a pricing module generating a pricing information by setting a price of the product, wherein the price of the product set at the value where the purchase group information matches with the discount information.

2. The system of claim 1, wherein the discount information includes a discount rate information and the discount rate information varies according to the purchased number of product.

3. The system of claim 2, wherein the prepared number of product is divided into multiple intervals and the discount rate information varies differently at each of the multiple intervals.

4. The system of claim 1, wherein the discount information is formed as a function graph of
Price=−{(Customer price−Lowest set price)/Prepared number of product}*Purchased number of product+Customer price},
the purchase group information is formed as a bar graph corresponding the purchased number of product and the bid price into the x-axis and the y-axis, respectively;
the varying price information is represented as a graph by adding the discount information and the purchase group information.

5. The system of claim 1, wherein the sale condition information includes information on a sale set period, the customer price in the function formula of the discount information is transferred to the customer price that additionally subtracts the value of {Basic discount price*[(sale date number−1)/sale set period]} thereby enabling the discount information to vary with the flow of time by including a basic discount price arbitrarily set by a function formula of discount information and the number of dates for sale showing the number of dates elapsed from a start date for sale.

6. The system of claim 1, wherein the pricing module further includes a pricing information transfer unit that extracts a customer who entered a bid price lower than the pricing information from the purchase group information and transfers the pricing information generated within the sale set period to the customer.

7. The system of claim 1, further comprises:
a URL information input unit that receives from a customer a URL information of a social network community operated by the customer where the advertising information on the product is posted;
a text determination unit generating a text level information that decides a degree of promotion of the advertising information by extracting the advertising information and analyzing it with text mining;
a social promotion management module includes an additional discount provision unit providing a differentiated discount to the customer according to the text level information.

8. The system of claim 7, wherein the advertising information includes a link icon linked to a webpage operated by the system;
the social promotion management module includes a link information extraction unit generating link information by extracting and counting log information showing access by an unspecified internet user through the link icon to a webpage operated by the system;
the additional discount provision unit provides a differentiated discount to the customer according to the value of the sum of the text level information and the link information.

9. The system of claim 1, further comprises:
an interest index extraction unit calculating each interest index of multiple products;
a product bundle generation unit generating product bundle contents extracting at least more than one product with a high interest index, thereby enabling the products to be sold simultaneously;
a product bundle management module includes a product bundle information transfer unit transferring product bundle information to a customer who enters the purchase condition information for one of the products included in the product bundle contents.

10. The system of claim 1, further comprises:
a customer invitation module that invites other customers to the pricing system by receiving the other consumers' information from the customer;
an invitation discount module discounting the price for an inviting customer, according to the number of customers who entered the bid price higher than the pricing information among the invited customers.

11. The system of claim 10, wherein the invitation discount module discounts the price for an inviting customer by a certain amount, wherein the certain amount is calculated by multiplying the invitation discount rate (%) with the number of customers who entered the bid price higher than the pricing information among the invited customers.

12. The system of claim 10, wherein the invitation discount module discounts the price for the invited customers by the invitation discount rate (%).
